(19) United States
(12) Patent Application Publication
(10) Pub. No.: US 2007/0171308 A1
(43) Pub. Date: Jul. 26, 2007

(54) Methods of color index searching

(76) Inventors: Chih-Lin Hsuan, Taipei (TW); Hong-Hui Chen, Hsinchuang City (TW); Hsi-Kang Tsao, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/339,396

(22) Filed: Jan. 25, 2006

(51) Int. Cl. H04N 9/64

(52) U.S. Cl. 348/649

(57) ABSTRACT

A method of color index searching in a color picture. An estimated color index X and an estimated range Y are obtained. An index range is set according to the estimated color index X and the estimated range Y. A color dimension of color signals corresponding to the index range is altered to make the color signals responding to the color dimension alteration. It is determined whether a designated region is responsive. If the designated region is not responsive, the estimated color index X is changed to update the index range for another color dimension alteration. If the designated region is responsive, the estimated range Y is reduced to update the index range for another color dimension alteration. If the estimated range reaches an acceptable range, the color index of the designated regions is found.

### BACKGROUND OF THE INVENTION

1. Field of the Invention

The invention relates to color image processing, and more particularly, to a method of color index searching in a color picture.

2. Description of the Related Art

In color-television systems, a chrominance signal is typically represented by two color signals, I and Q (or U and V), wherein I and Q signals are Cartesian coordinates of the chrominance signal and linear transformation of the U and V signals. Whether a chrominance signal is encoded into I and Q signals or U and V signals depends on the standard a video system adopts. In the NTSC standard, I and Q signals are transmitted simultaneously as quadrature-modulated waves using a single chrominance subcarrier. I and Q signals are separated from the chrominance signal by demodulating with the chrominance subcarrier, and subsequent color image processing is performed on the two color signals. I and Q signals precisely specify the location of the respective picture element in a color plane. Additionally, a luminance signal is fed to a separate processing stage and subsequently combined with the two color signals in a color matrix to generate the value for red (R), green (G), and blue (B) signals.

The chrominance signal can also be represented by polar coordinates comprising a magnitude signal and an angle signal. The angle signal carries the hue information, and the magnitude signal carries the saturation information of the chrominance signal.

Color adjustment is typically required in color image processing, especially for preferred colors such as flesh-tone, grass green, and sky blue.

### BRIEF SUMMARY OF THE INVENTION

A method of color index searching in a color picture is provided. In one embodiment, an estimated color index X and an estimated range Y are obtained. An index range is set according to the estimated color index X and the estimated range Y. A color dimension of color signals corresponding to the index range is altered in a specific manner to make the color signals responding to the color dimension alteration. It is determined whether a designated region is responsive to the color dimension alteration. If the designated region is not responsive, the estimated color index X is changed to update the index range, and another color dimension alteration is executed. If the designated region is responsive, the estimated range Y is reduced to update the index range for another color dimension alteration. If the estimated range reaches an acceptable range, the color index of the designated regions can be found.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an embodiment of a method of color index searching in a color picture.

### DETAILED DESCRIPTION OF THE INVENTION

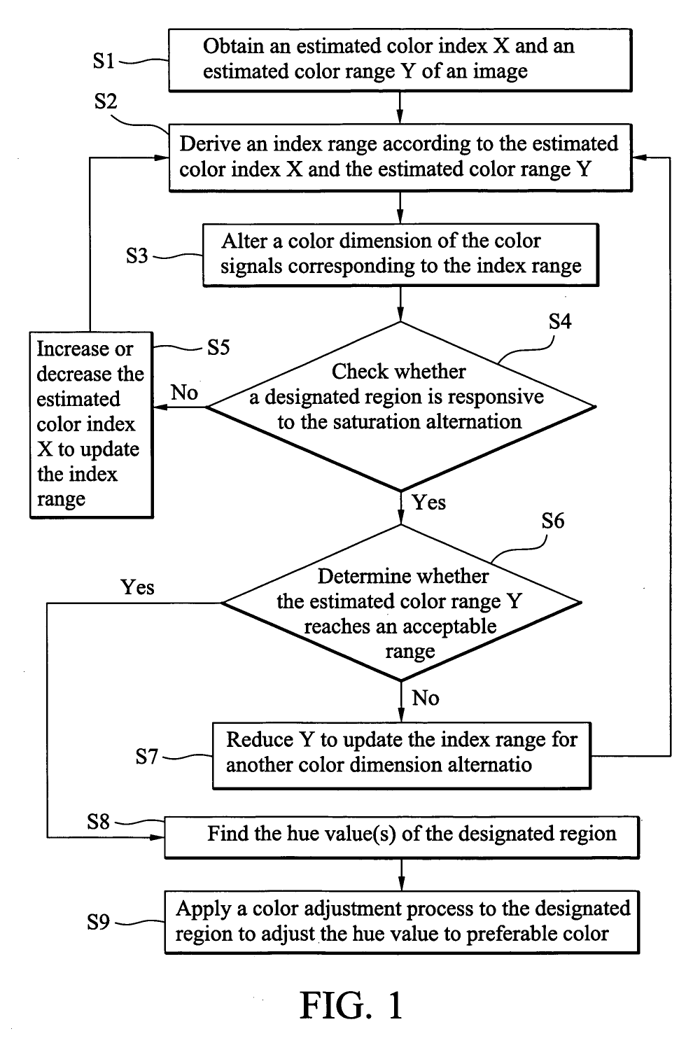

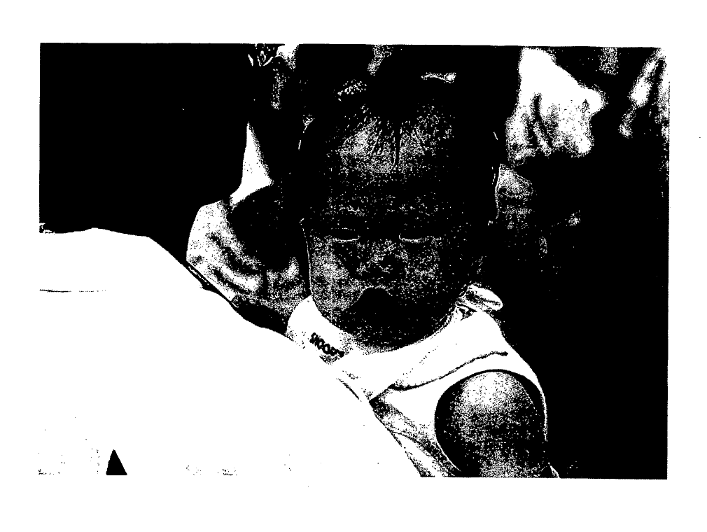

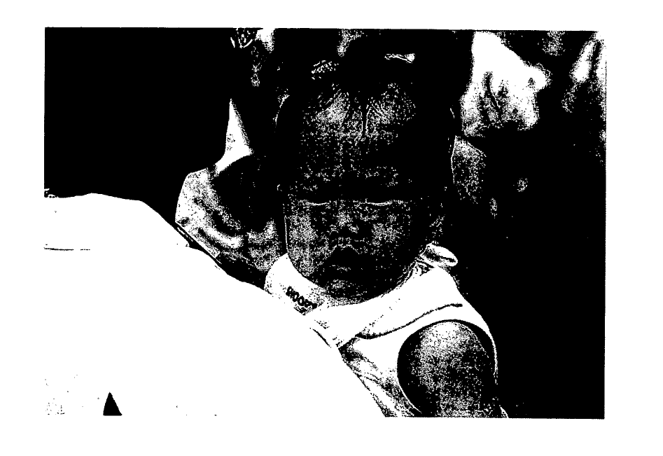

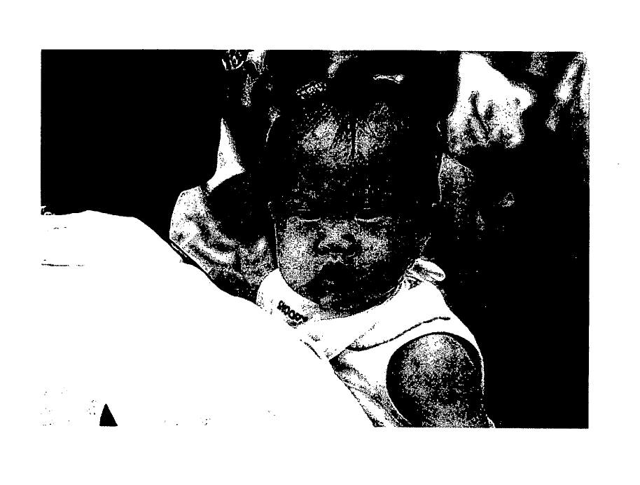

Several exemplary embodiments of the invention are described with reference to FIG. 1, which generally relate to color index searching in a color picture. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses methods of color index searching in a color picture. The following first describes the basic principle of color display relating to color models.

Two common color models in imaging are RGB (Red, Green, and Blue) and CMY (Cyan, Magenta, and Yellow), and two common color models in video are YUV and YIQ (defining color by luminance and chrominance measures). RGB is an additive color model that is frequently used for light-emitting devices, such as CRT (Cathode Ray Tube) displays. Different color projections emitted from the Red, Green and Blue color guns are voltage-controlled according to the RGB values.

YUV model is used by PAL system of TV industry, where Y stands for color luminance, U and V stand for chrominance in color signals. The weighted values of R, G, and B are added to produce the Y signal representing the overall brightness of a particular spot. The U and V signals are the scaled difference between Y and blue/red signals. YUV is suitable for TV industry due to its compatibility with black and white analog TV and its effective use of bandwidth. The design is based on the fact that human eye is more sensitive to deviation in light brightness than to slight changes in color, therefore bandwidth is increased for brightness and decreased for color.

Beside those hardware-oriented color models, HSB (Hue, Saturation, and Brightness) model is also commonly used in computer graphics applications. Hue specifies the color type using a color space separating Red, Green and Blue in 120° intervals. An angle is given to determine the hue, for instance, H=60° indicates yellow. Saturation determines “vibrancy” or “purity” of the color. A value near to 0 stands for a light color closes to white. The lower the saturation of a color, the more “grayness” is present and the more faded the color will appear. The Brightness determines the gray scale. The lower the gray scale the brighter the color.

In an exemplary embodiment, the HSB model is applied for color index searching, but the invention is not intended to be limiting to the HSB model.

FIG. 1 is a schematic view of an embodiment of a color index searching method for a system implementing the HSB model for color presentation.

As previously described, the color space of the HSB model is formed by separating red, green, and blue in 120° intervals. During color signal processing, tuning a variable (e.g., Hue, Saturation, or Brightness) of a designated spot or region is sometimes preferred to enhance the visual perception of the color image. For example, it is desirable to tune the hue value of the color signal corresponding to a region of human lips to display a bright red color. In this case, the original hue value corresponding to the lips region has to be known so it can be properly tuned, and thus the hue value is designated as the color index. An estimated color index X and an estimated color range Y of an image are obtained as initial values for color index searching (step S1), and an index range is derived according to the estimated color index X and the estimated color range Y (step S2). The index range includes color indexes from X−Y (the estimated color index subtracts the estimated range) to X+Y (the estimated color index adds the estimated range). A color dimension of the color signals corresponding to the index range is altered to make the color signals responding to the color dimension alternation (step S3). An exemplary color dimension is the saturation value, and the saturation can be altered by periodically switching the saturation value corresponding to the index range between a large value and a small value at a constant frequency. Alternatively, the saturation value corresponding to the index range may be altered according to a specific pattern.

It is noted that the color index and the color dimension are two different measures of the color signals, for examples, chrominance and luminance measures, or red (R), green (G), and Blue (B) components. The chrominance measures may be hue and saturation components, or two Cartesian components such as (U,V) or (I,Q).

Step S4 checks whether a designated region is responsive to the saturation alternation (step S4). If not, the hue value(s) corresponds to the designated region is not included in the index range, so that the estimated color index X is increased or decreased (step S5) to update the index range for another color dimension alternation (step S2).

If the designated region is responsive, it is then determined whether the estimated color range Y reaches an acceptable range (step S6). In an embodiment, a specific hue value corresponding to the designated region can be found by setting the acceptable range to zero. If Y is greater than the acceptable range, it is reduced (Step S7) to update the index range for another color dimension alternation (step S2). If the estimated color range Y is equal to or less than the acceptable range, the hue value(s) of the designated region is found (step S8). A color adjustment process can be applied to the designated region to adjust the hue value to preferable color (step S9).

In an example of displaying a color image on a monitor, the estimated color index X (e.g., hue value) is initially set as 100°, and the estimated color range Y is 10°. An index range is derived as 90° to 110°, (X−Y, X+Y)=(90, 110). A color dimension (e.g., saturation or brightness value) corresponding to the index range (hue values within the range of 90° to 110°) is alternatively set according to a specific pattern, for example, switching the saturation value between its maximum and minimum values every 0.5 seconds. As a result, regions with the hue value belong to the index range 90°˜100° will respond to the purposely alteration of the saturation value, for example, the regions twinkle regularly. The above process is referred to as color dimension alteration in later descriptions.

When a designated region corresponding to the index range (90°˜110°) is not responsive, indicating the hue value of the designated region is not included in the index range, such that X should increase (or decrease) by, for example, 20, and thus X=120°. A new index range 110°˜130° (120−10, 120+10) is derived and the color dimension alteration process is repeated for the updated index range.

When a designated region corresponding to the index range (90°˜110°) is responsive, but if an acceptable range for Y is set to 0, Y must be decreased to narrow the index range. For example, when Y is reduced to 5°, a new index range 95°˜105° (100−5, 100+5) is derived and the color dimension alteration process is repeated according to the updated index range.

When Y is reduced to the acceptable region, for example, Y=0, the color index (104°, for example) corresponds to the designated region is found.

Parameter setting and tuning for the color index searching process may be implemented in an automatically, semi-automatically, or manually manner. In an automatic color index searching process, the estimated color index X and the estimated color range Y are automatically modified in accordance with predetermined rules when the color index corresponding to the designated region is not yet acquired. Additionally, the whether the designated region is responsive to the dimension alteration process may be observed or detected by a sensor.

An example for realizing the color index searching of the invention is described with reference made to the accompanying drawings.

Referring to Attachment 1, an objective is to find color indexes (e.g., hue values H, ranging from 0° to 360°) corresponding to the nose of the child in the picture. The estimated color index X is first set to, for example, 102°, and the estimated color range Y may be set to, for example, 0°, such that the index range contains only one degree, and reducing Y is no longer required. Next, the color dimension (e.g., saturation values S, ranging from 0 to 1) corresponding to H=102° is set to switched between two extreme values, S=0 and S=1. As shown in Attachment 2, regions with H=102° changes its color between gray and red. However, the nose region is not responsive, indicating that the nose region is not constituted by color with H=102°. The estimated color index X is then set to, for example, 93°. As shown in Attachment 3, the nose region is responsive since switching the saturation makes the nose region twinkling, indicating the color index X of the nose region is found to be 93°.

As described, a method for color index searching of the invention can rapidly locate colors corresponding to designated regions of an image displayed in a monitor for further color manipulation. The color index is not limited to a HSB component, it can be a measure obtained by classifying the color image in accordance with a characteristic. The disclosed embodiments provide methods for finding colors of a particular region in a color picture without complicated algorithms or additional hardware. Compared with other image analysis methods, for example, dumping full screen data to dynamic random access memory (DRAM), the provided color index searching methods achieve high-speed processing and does not require DRAM dump tools. Furthermore, the provided color index searching methods ensure high security as dumping and disclosing the source codes are no longer required during color processing. Furthermore, the provided methods can locate colors with particular color index(s) on a displayed picture, or analyze the color distribution of the displayed picture.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of color index searching in a color picture, comprising:
obtaining an estimated color index X and an estimated range Y;
setting an index range according to the estimated color index X and the estimated range Y;
altering a color dimension of color signals corresponding to the index range to make the color signals responding to the color dimension alteration;
determining whether a designated region is responsive;
if the designated region is not responsive, changing the estimated color index X to update the index range for another color dimension alteration;
if the designated region is responsive, reducing the estimated range Y to update the index range for another color dimension alteration; and
if the estimated range reaches an acceptable range, the color index of the designated regions is found.

2. The method of searching color index as claimed in claim 1, wherein the index range includes color indexes from X-Y (the estimated color index subtracts the estimated range) to X+Y (the estimated color index adds the estimated range).

3. The method of searching color index as claimed in claim 1, wherein the color dimension alteration comprises periodically switching the color dimension of the color signals corresponding to the index range between a large value and a small value.

4. The method of searching color index as claimed in claim 3, wherein the color dimension is switching between a maximum value and a minimum value at a constant frequency.

5. The method of searching color index as claimed in claim 3, wherein the color dimension alteration comprises altering the color dimension of the color signals corresponding to the index range according to a specific pattern.

6. The method of searching color index as claimed in claim 1, wherein the color index and the color dimension are two different measures of the color signals.

7. The method of searching color index as claimed in claim 6, wherein the measures of the color signal comprise chrominance and luminance measures, or red (R), green (G), Blue (B) components.

8. The method of searching color index as claimed in claim 7, wherein the chrominance measure comprises hue and saturation components, or two Cartesian components.

9. The method of searching color index as claimed in claim 1, further comprising adjusting the color index of the designated region.

10. A computer-readable storage medium storing a computer program providing a method of color index searching in a color picture, comprising using a computer to perform the steps of:
obtaining an estimated color index X and an estimated range Y;
setting an index range according to the estimated color index X and the estimated range Y;
altering a color dimension of color signals corresponding to the index range to make the color signals responding to the color dimension alteration;
determining whether a designated region is responsive;
if the designated region is not responsive, changing the estimated color index X to update the index range for another color dimension alteration;
if the designated region is responsive, reducing the estimated range Y to update the index range for another color dimension alteration; and
if the estimated range reaches an acceptable range, the color index of the designated regions is found.

11. The computer-readable storage medium as claimed in claim 10, wherein the index range includes color indexes from X−Y (the estimated color index subtracts the estimated range) to X+Y (the estimated color index adds the estimated range).

12. The computer-readable storage medium as claimed in claim 1, wherein the color dimension alteration comprises periodically switching the color dimension of the color signals corresponding to the index range between a large value and a small value.

13. The computer-readable storage medium as claimed in claim 12, wherein the color dimension is switching between a maximum value and a minimum value at a constant frequency.

14. The computer-readable storage medium as claimed in claim 12, wherein the color dimension alteration comprises altering the color dimension of the color signals corresponding to the index range according to a specific pattern.

15. The computer-readable storage medium as claimed in claim 10, wherein the color index and the color dimension are two different measures of the color signals.

16. The computer-readable storage medium as claimed in claim 15, wherein the measures of the color signal comprise chrominance and luminance measures, or red (R), green (G), Blue (B) components.

17. The computer-readable storage medium as claimed in claim 16, wherein the chrominance measure comprises hue and saturation components, or two Cartesian components.

18. The computer-readable storage medium as claimed in claim 10, further comprising adjusting the color index of the designated region.
